(19) United States
(12) Patent Application Publication
(10) Pub. No.: US 2008/0168260 A1
(43) Pub. Date: Jul. 10, 2008

(54) Symbolic Execution of Instructions on In-Order Processors

(76) Inventors: Victor Zyuban, Yorktown Heights, NY (US); Michael K. Gschwind, Chappaqua, NY (US); John-David Wellman, Hopewell Junction, NY (US)

Correspondence Address: IBM CORPORATION, T.J. WATSON RESEARCH CENTER, P.O. BOX 218, YORKTOWN HEIGHTS, NY, 10598, US

(21) Appl. No.: 11/620,790

(22) Filed: Jan. 8, 2007

(51) Int. Cl. G06F 9/312

(52) U.S. Cl. 712/214; 712/E09.033

(57) ABSTRACT

A method is provided for processing instructions by a processor, in which instructions are queued in an instruction pipeline in a queued order. A first instruction is identified from the queued instructions in the instruction pipeline, the first instruction being identified as having a dependency which is satisfiable within a number of instruction cycles after a current instruction in the instruction pipeline is issued. The first instruction is placed in a side buffer and at least one second instruction is issued from the remaining queued instructions while the first instruction remains in the side buffer. Then, the first instruction is issued from the side buffer after issuing the at least one second instruction in the queued order when the dependency of the first instruction has cleared and after the number of instruction cycles have passed.

This invention was made with Government support under Contract No.: NBCH3039004 awarded by Defense Advanced Research Projects Agency (DARPA). The Government has certain rights in this invention.

### BACKGROUND OF THE INVENTION

The present invention relates to information processing systems, and more specifically to information processing systems which are capable of executing any of a set of valid instructions, typically presented for execution in form of programs.

There exist two major types of general purpose microprocessors, referred to herein as “processors”. A first type, known as “in-order issue” processors, issue instructions for execution usually only in the same order in which the instructions enter a pipeline used for decoding and issuing instructions. A second type, known as out-of-order issue processors, are capable of issuing instructions for execution in an order different from that in which the instructions enter a corresponding instruction issue and decode pipeline.

Out-of-order issue processors often achieve higher architectural performance in terms of instructions executed per cycle (“IPC”) than in-order issue processors. Out-of-order issue processors can continue issuing instructions for execution even when the execution of one or more preceding instructions is stalled, i.e., those instructions are temporarily not yet executable. For example, when an instruction in the pipeline depends upon the result of executing a preceding instruction ahead of that instruction in the pipeline, the later instruction is said to have a “dependency” upon the result of the preceding instruction. In such case, even though execution of the preceding instruction is stalled, the out-of-order issue processor continues to issue and execute other instructions which do not have that dependency. In addition, the performance of out-of-order processors is typically less sensitive to the properties of the executed code such as inter-instruction dependency distance, cache miss rate, etc. than in-order processors. This makes the performance and behavior of out-of-order processors more stable and predictable.

On the other hand, in-order issue processors generally have lower development cost, occupy smaller area of a semiconductor chip, and can execute instructions at potentially higher frequency (shorter machine cycle) than out-of-order issue processors.

An exemplary out-of-order issue processor 100 in accordance with the prior art is illustrated in FIG. 1. The particular type of processor shown in FIG. 1 is constructed to operate in accordance with the known “Tomasulo” algorithm. In such processor, instructions enter an instruction decoder 120 from storage 110, which typically includes cache for quick and ready storage access. The decoder gives each instruction a name, i.e., a “tag”, and identifies any dependencies upon which the execution of each particular instruction depends. The tags for each instruction are recorded in a decoded instruction buffer 130 and any dependency of the instruction is identified in terms of the identity of a register 135 on the processor which is to contain data or other execution result upon which the later instruction depends. Typically, the dependency is recorded in terms of a register number. After identifying the dependencies, if any, of each instruction, instructions are placed in sets 140a, . . . , 140n of “reservation stations”, each set of reservation stations corresponding to a corresponding functional unit 150a, . . . , 150n, arranged to execute instructions of the processor 100. Each reservation station is represented by a horizontally extending row, e.g., row 141, of one of the sets 140a, 140n of reservation stations. The labels “source”, “sink” and “ctrl” which appear in each reservation station relate to dependencies. For example, a “source” relates to a resource needed for execution, and “sink” and “ctrl” relate to tracking other aspects of dependencies.

Simply put, the dependencies of the instructions in each set of reservation stations are monitored and each instruction is released from its reservation station to be executed by the corresponding functional unit whenever the dependencies are satisfied. For example, the instruction represented by reservation station 141 is released for execution by functional unit 150a when data needed for executing that instruction has become available in a register designated therefor.

One disadvantage of the out-of-order issue mechanism shown in FIG. 1 is the relatively large amount of semiconductor are required to implement the decoded instruction buffer and the sets of reservation stations. Another disadvantage is that when there are large numbers of reservation stations, the time required to check whether dependencies of each instruction in a set of reservation stations are satisfied can be considerable. The time needed to perform such checking can actually limit how fast the machine cycle of the processor can be set.

By contrast, an example of an implementation of issue logic and stall logic of a prior art in-order issue processor is shown in FIG. 2. As illustrated therein, an instruction fetch component 11 is responsible for fetching instructions and providing instructions for decoding and issue in the program order. Instruction buffer component 12 is a buffer that can hold one or more instructions. Depending on the implementation, the instruction buffer may hold instructions until they are accepted by the next component down the processor pipeline, until the instructions are executed or otherwise completed (e.g., “retired”). Instruction buffer 12 is an optional component. The decode component 13 is responsible for decoding instructions and extracting the names of the operands (operands IDs) of each instruction. An operand is a unit of data or other information, typically held temporarily in a register for use during execution of an instruction. The operand IDs are sent to the dependency checking logic 14 that determines whether the source operands are available. When all source operands of a particular instruction are available, as determined by dependency checking logic 14, the issue stage 15 of the instruction pipeline issues the instruction for execution by one or more functional units of the processor.

The dependency checking logic 14 consists of the following components: Target table 31 which holds information about the most resent updates for each of the register of the architected processor state. The required information stored in the target table is the name of the unit producing the most recent update for that register and the number of cycles after which the update will becomes available to the following instructions either through the register file or the bypass. The dependency checking logic 34 analyzes the information read out from the target table and determines if a dependency stall is needed to be forced in order to ensure the correct execution of the program.

The resource stall logic 33 checks if the issue of instructions in the issue stage 15 of the instruction issue pipeline may result in a resource conflict. For example if the number of units needed to execute the group of instructions in the issue stage of the processor exceeds the number of units available in the processor, a resource stall is forced. All remaining stalls are analyzed by the “other stall” logic 32. This logic enforces stalls needed for the execution of multi-cycle instructions, as well as stalls for instructions that are implemented as microcode, and instructions which require the instruction issue pipeline to be drained, such as when an instruction cannot possibly be executed (an instruction “exception”). The stall logic 35 combines all stall conditions and generates the stall signal that stalls the issue stage 15 (and possibly also the decode stage 13 and the instruction fetch stage 11 and/or instruction buffer stage 12) of the pipeline.

In one example, if all source operands of the instruction are available, the instruction is determined to have no unsatisfied dependency, clearing the way for the issue logic 15 to issue the instruction for execution. However, one or more source operands of an instruction may be unavailable pending determination of the value of the operand, for example, by a preceding instruction in the instruction issue pipeline. This can occur when the preceding instruction itself has either not been issued yet or otherwise has not yet finished execution. If one or more source operands of the instruction are not available, the dependency is unsatisfied at that point in time, and the instruction is therefore stalled prior to be issued until the preceding instruction that produces the input operands has finished being executed.

However, the dependency checking logic 14 has the effect of stalling not only an instruction which itself has an unsatisfied dependency, but also every instruction in the instruction issue pipeline that follows such stalled instruction. Because of this, considerable and hard to predict delays can occur during execution of programs on an in-order-issue processor 10 such as that shown in FIG. 2.

### SUMMARY OF THE INVENTION

In accordance with an aspect of the invention, a method of processing instructions by a processor, in which instructions are queued in an instruction pipeline in a queued order. A first instruction is identified from the queued instructions in the instruction pipeline, the first instruction being identified as having a dependency which is satisfiable within a number of instruction cycles after a current instruction in the instruction pipeline is issued. The first instruction is placed in a side buffer and at least one second instruction is issued from the remaining queued instructions while the first instruction remains in the side buffer. Then, the first instruction is issued from the side buffer after issuing the at least one second instruction in the queued order when the dependency of the first instruction has cleared and after the number of instruction cycles have passed.

### BRIEF DESCRIPTION OF THE DRAWINGS

FIG. 1 illustrates an exemplary out-of-order issue processor in accordance with the prior art.

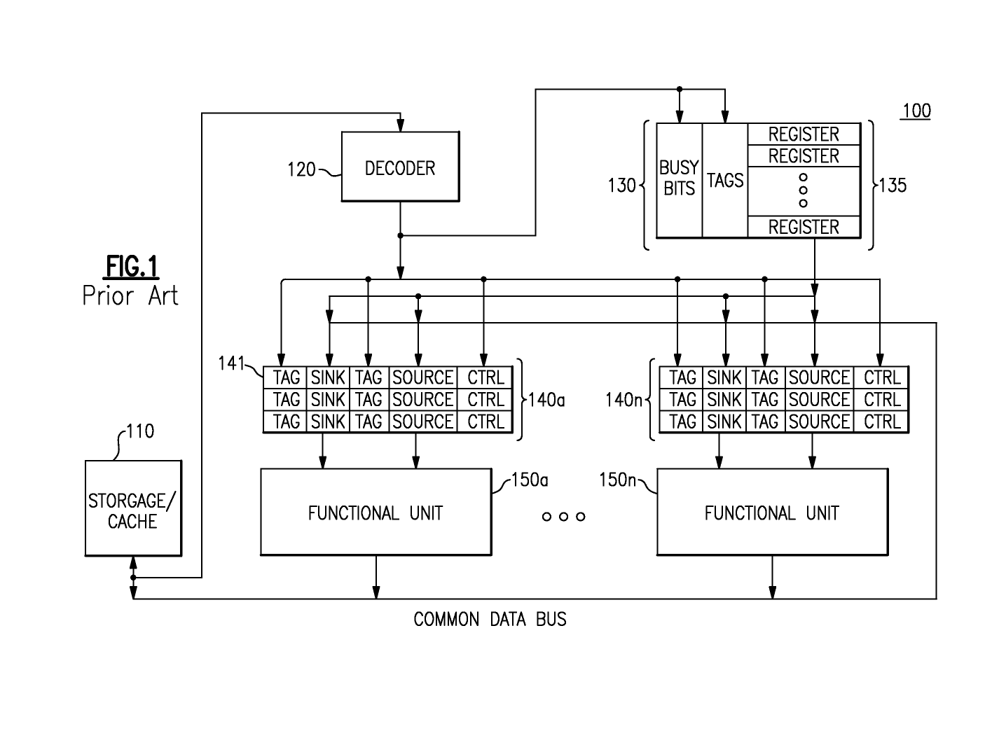

FIG. 2 illustrates exemplary in-order issue processor in accordance with the prior art.

FIG. 3 is a block and schematic diagram illustrating a processor in accordance with an embodiment of the invention.

FIG. 4 is a block and schematic diagram illustrating exemplary dependency checking and instruction side buffer control logic for a processor in accordance with an embodiment of the invention.

FIG. 5 is a block and schematic diagram illustrating an instruction side buffer and issue logic for a processor in accordance with an embodiment of the invention.

FIG. 6 is a flowchart illustrating a method of symbolically executing instructions in accordance with an embodiment of the invention.

FIG. 7 is a flowchart illustrating a method of executing instructions in accordance with an embodiment of the invention.

### DETAILED DESCRIPTION

The symbolic execution mechanism in accordance with embodiments of the invention disclosed herein enables some of the benefits of the out-of-order issue processors described above while avoiding disadvantages such as the high overhead of the prior-art out-of-order issue mechanisms.

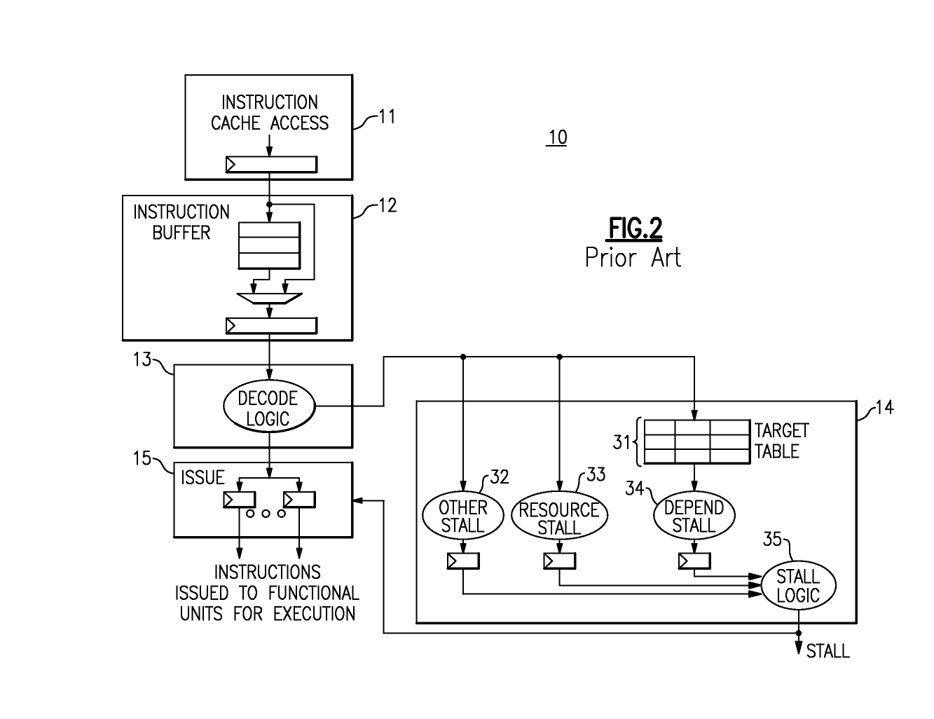

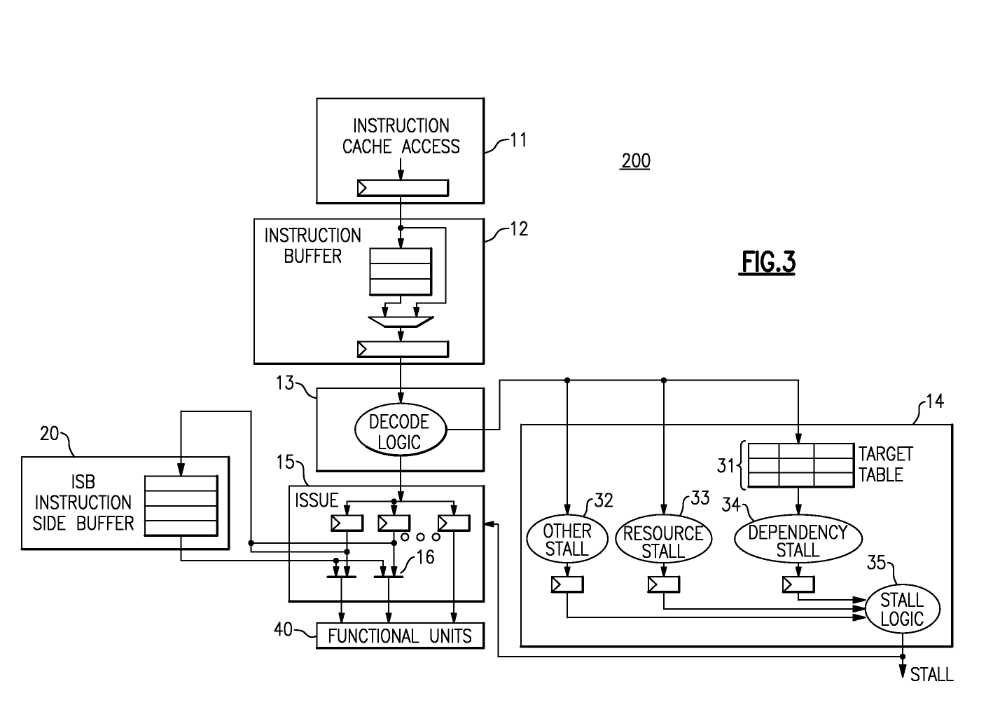

FIG. 3 illustrates elements of a processor 200 in accordance with a preferred embodiment of the invention. In addition to elements 11, 12, 13, 14 and 15 included in the processor 200, which are as shown and described above (FIG. 2), an instruction side buffer (ISB) is also included. Unlike the operation of the instruction issue in the prior art, when the issue logic processes an instruction which has a dependency, i.e., which depends on an operand which is unavailable (for example due to a pending update from an earlier instruction), the instruction is allocated an entry in the ISB 20. During the time that such instruction remains in the ISB, the issue of instructions following that particular instruction is not stalled. Instead, the processor 200 continues to issue and execute instructions in the order in which they are queued in the instruction pipeline, even though such instructions occur in the instruction pipeline in an order later than the instruction which is placed in the ISB.

Preferably, upon placing the instruction that has the dependency in the ISB, that instruction is issued and executed symbolically. Later when the dependency is satisfied, that instruction is executed normally. An instruction is said to be executed symbolically when it goes through the execution pipeline, possibly reads the source operands from the register file or receives the source operands through one of the bypasses, checks the exception conditions, but does not write the result to the register file. Instead of writing to the register file the produced value, the symbolically executed instruction may write some control information to the register file, such as a pointer to the corresponding entry in the instruction side buffer or, in an alternative embodiment, it may not write the register file. The symbolically executed instruction waits in the instruction side buffer until all its input operands are available. After that it is marked as ready for execution, and it waits for an available issue slot. In one embodiment, instructions marked as ready in the instruction side buffer may wait until there is an empty issue slot from the issue stage of the processor due to a stall, or an insufficient number of instructions ready for issue from the decode-issue pipeline of the processor. Alternatively, if the number of ready instructions in the instruction side buffer exceeds a certain threshold, the instruction side buffer may force a stall in the decode-issue pipeline, and use the freed issue slots to issue one or more of the instructions marked as ready. When an instruction that had been executed symbolically is issued from the instruction side buffer, it reads the values of the source operands from the register file, or gets them from one of the bypasses, or from an implementation-dependent dedicated storage, computes the value and writes it back to the register file. The corresponding entry in the instruction side buffer is cleared.

If the processor 200 encounters an exception condition or a change in the control flow due to an instruction which is younger (enters the instruction fetch component 11 later) than an instruction in the instruction side buffer, the corresponding instruction (or instructions) from the instruction side buffer are executed and are allowed to write the produced values into the register file before the processor takes any corrective action such as branch redirect or trap. Thus, when an instruction enters the instruction side buffer, it is considered completed from the viewpoint of exceptions and changes in the instruction flow, but it's result is not available in the register file until it is issued from the instruction side buffer and executed normally. Hence, instructions entering the instruction side buffer are said to be executed symbolically.

As shown in FIG. 3, the ISB 20 may accept instructions from one or more issue slots 15. The instruction side buffer may have one or more entries. Instructions issued from the instruction side buffer go through multiplexors 16, where they are multiplexed with the outputs of the instruction issue stage of the processor 15. In one embodiment, the instruction side buffer may issue for execution one or more instructions per cycle. The issue of instructions from the instruction side buffer may be limited to a subset of issue slots, as shown in FIG. 3.

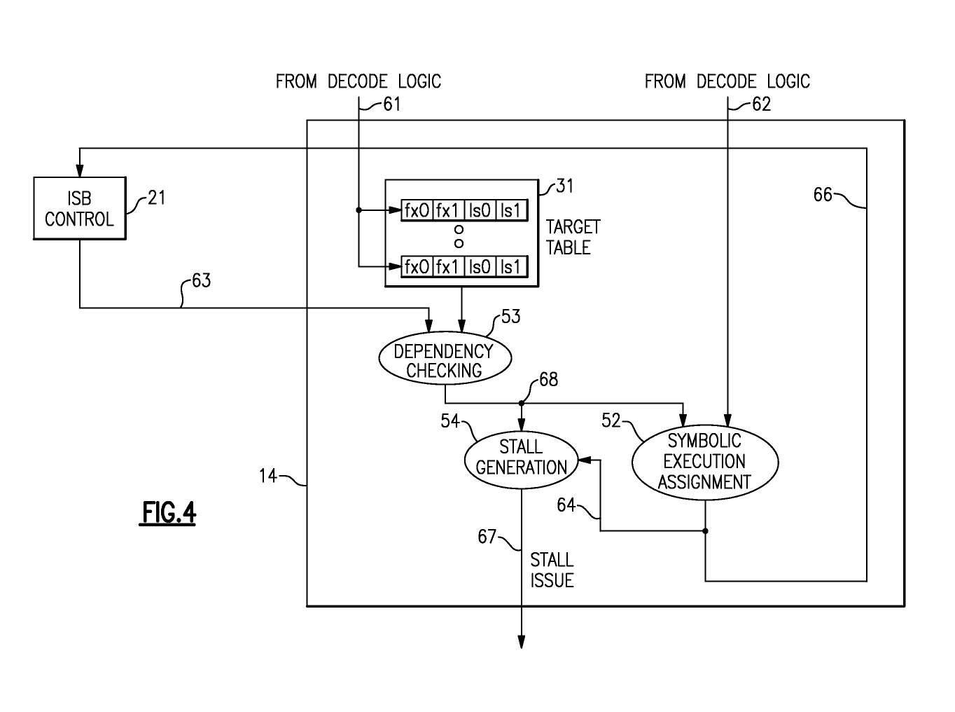

FIG. 4 shows an embodiment of the dependency checking and stall logic 14 (FIG. 3) to support symbolic instruction execution in accordance with an embodiment of the present invention. From decode logic 13 (FIG. 3) signals 61 indicates the names (IDs) of the source and destination operands for each instruction that enters the dependency checking and issue logic. These signals are used to access the target table 31 which stores information about pending updates to architectural registers (such as the name of the unit that generates an update and the number of cycles before the corresponding update becomes available in the register file or through a bypass). This dependency information, read out of the target table, enters the dependency checking logic 53 which analyzes the operand dependency information and generates the dependency stall signal 68 when stalling the issue stage is necessary to clear the dependencies.

The Instruction Side Buffer control logic 21 supplies to the dependency checking logic 53 information about the target operands of instructions stored in the instruction side buffer. This information is supplied through signals designated as 63 in FIG. 4. In particular, the IDs of the destination (target) operands of instructions in the instruction side buffer are used to override the corresponding bits read out of the target table 31. The dependency information about registers written by instructions executed symbolically in the target table 31 may be incorrect. Even though the corresponding bits in the target table 31 may indicate that the operand in the register file is available, the actual value may not have been produced yet if an instruction writing that register was executed symbolically.

The dependency stall signal 68 is supplied to the stall generation logic 54 which evaluates stall requests from other sources of stalls, as described earlier and shown in FIG. 3. The stall logic 54 generates the stall signal 67 which is used to stall the issue stage of the processor. The stall logic 54 also receives signals indicating if one of the instructions in the issue stage of the processor is entering the instruction side buffer. This information is generated by the symbolic execution assignment logic 52 and is passed as signal designated as 64 in FIG. 4. This information is used to modify the stall conditions. If an instruction in the issue stage of the processor has an unresolved dependency, which therefore would have caused the issue stall in the prior art implementation of the issue logic, but this instruction has been designated for symbolic execution, the stalling of the issue in the embodiment of the present invention is not needed, and the issue stall signal 67 is not asserted.

The symbolic execution assignment logic 52 designates instructions for symbolic execution. It receives control information from the decode logic about every instruction entering the issue logic which indicates for every instruction if it is eligible for symbolic execution. The corresponding signals are designated as 62 in FIG. 4. Depending on an embodiment, one or more of the following conditions may be imposed as a requirement for eligibility for symbolic execution. Instruction can be placed into the instruction side buffer only if it cannot raise exception and/or it satisfies a set of limiting conditions such as only one of the source operands must be unavailable, or the instruction must be in integer instruction, or the instruction must belong to a pre-determined subset of op-codes.

The symbolic execution assignment logic also receives the dependency information from the dependency checking logic 53. If an instruction is eligible for symbolic execution and if it has an unresolved dependency, it is assigned to be executed symbolically. Then the symbolic execution assignment logic 52 signals the stall generation logic that it can proceed with instruction issue, that is it may disregard the stall conditions associated with instructions designated for symbolic execution (marked as signal 64 in FIG. 4). The symbolic execution assignment logic also sends control signals (marked as 66 in FIG. 4) to the Instruction Side Buffer indicating that it must accept the corresponding instruction from the issue logic. The symbolic execution logic may also supply information to the instruction side buffer indicating the minimum number of cycles that an instruction entering the instruction side buffer must spend in the instruction side buffer before the operand dependency is cleared (that is before the operand that caused the entry of the instruction into the instruction side buffer is available in the register file or through a bypass).

Embodiments of this invention may or may not target the elimination of single-cycle stalls. For example, the symbolic execution may be limited to instruction with dependencies that would have caused a multi-cycle stall, but not single-cycle stalls. Another embodiment of this invention may force a stall of the issue stage on the cycle that an instruction designated for symbolic execution enters the instruction side buffer, and thus only eliminate the second stall cycle and the following stall cycles. Embodiments may or may not allow the back to back issue of dependent instruction from the instruction side buffer, or the back to back issue of dependent instructions from the instruction side buffer and the issue stage of the processor. The exact positions of latches, the structure of the target table may vary from embodiment to embodiment, depending on the pipeline depth, frequency of the processor and other factors.

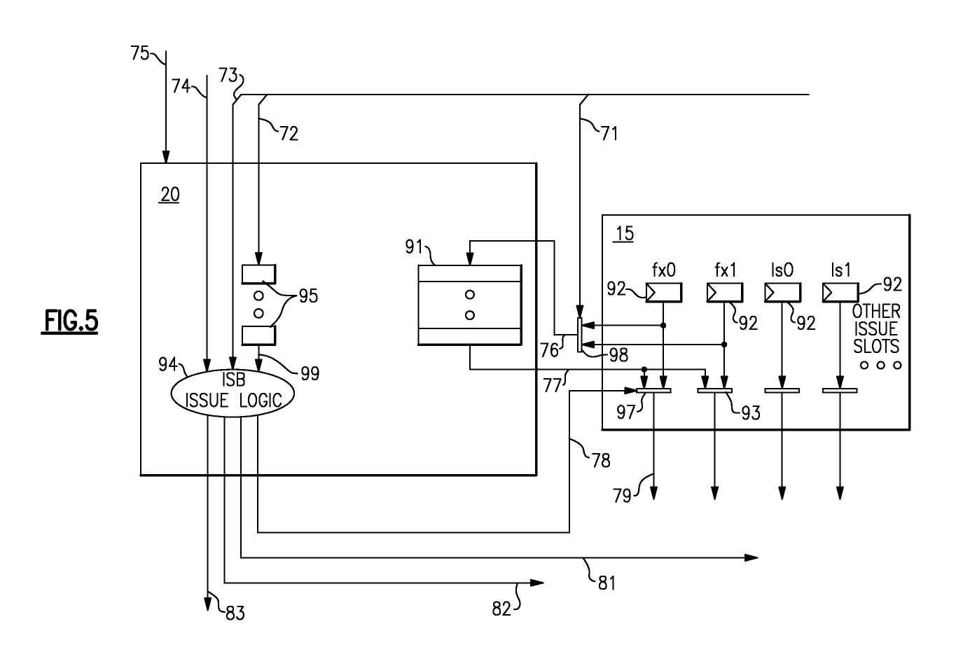

FIG. 5 shows implementation details of an instruction side buffer in accordance with one embodiment of the invention, and its interaction with the issue logic of the processor according to the preferred embodiment of this invention.

As in FIG. 3, box 20 in FIG. 4 shows the Instruction Side Buffer, and box 15 shows the issue logic of the processor. The issue logic of the processor implements registers 92 which hold instructions before instructions are issued to the execution units. There are four issue slots shown in FIG. 4: two issue slots for fixed point instructions (fx0 and fx1) and two issue slots for load/store instructions (Is0 and Is1). There may be other issue slots which are not shown in FIG. 4, such as branch instruction issue slots, floating point instruction issue slots, etc. Multiplexors 93 and 97 at the outputs of the issue slots fx0 and fx1 are implemented to allow instructions issued from the instruction side buffer to enter the execution pipeline. Instructions issued from the instruction side buffer are sent to the issue logic over a bus marked as 77 in FIG. 5. Even though only two multiplexors 93 and 97 in front of the fx0 and fx1 issue slots are shown in FIG. 5, an embodiment may implement similar multiplexors in front of any subset of the issue slots. The inputs of the issue multiplexors 93 and 97 are controlled by the Instruction Side Buffer issue logic 94 which make decisions every cycle regarding whether an instruction should be issued from the main issue logic 15 or from the instruction side buffer 20. The operation of this logic is described later.

Instructions designated for entering the instruction side buffer are sent from the issue logic 15 to the instruction side buffer 20 over bus 76. Multiplexor 98 selects from which of the issue slots an instruction will be sent to the instruction side buffer. This multiplexor 98 is controlled by the dependency checking logic, as shown in FIG. 4. The corresponding control signal is designated as 71 in FIG. 5. While multiplexor 98 in FIG. 5 can only select instructions from issue slots fx0 and fx1, embodiments may allow the selection of instructions to enter the instruction side buffer from any subset of the available issue slots. Upon entering the instruction side buffer, instructions are saved in a storage array 91 which may be implemented as a set of latches or a memory array. Some embodiments may implement the instruction storage 91 as a first-in-first-out (“FIFO”) buffer.

The instruction side buffer issue logic 94 is the central control component of the instruction side buffer which makes a decision every cycle regarding whether an instruction is issued for execution from the instruction side buffer. Embodiments may differ in the number of inputs or some specific details of the operation of this logic. In the embodiment shown in FIG. 5 the instruction side buffer logic has three main inputs. Signal 99 indicates that there is an instruction (or multiple instructions) in the instruction side buffer whose dependencies have been resolved, and therefore it is ready for issue. The logic generating the ready signal 99 is described later. The second input 73 is the stall signal which indicates when the issue logic 15 is stalled from issuing an instruction in a given cycle. The ISB issue logic uses this information in the following way. If there is an instruction in the ISB ready for issue and there is an issue stall in a particular cycle, then the ready instruction from the instruction side buffer is issued for execution. The control input 78 of the appropriate issue multiplexors 93 or 97 is asserted to allow the instruction from the instruction side buffer to enter the execution pipeline. The third input to the ISB issue logic is a resource vector from the decode logic which indicates which issue slots are used for the decoded group of instructions that enters the issue logic. This information is used by the ISB issue logic in the following way. If there is no issue stall in the issue logic of the processor, there are instructions in the instruction side buffer which are ready for execution, and there is an unused issue slot among instructions proceeding through the issue logic which can be used by the ready instruction in the instruction side buffer, then the ready instruction from the instruction side buffer is issued for execution. The control input 78 of the appropriate issue multiplexors 93 or 97 is asserted to allow the instruction from the instruction side buffer to enter the execution pipeline, using an issue slot which is not used by an instruction among the instructions currently proceeding through the issue logic.

In addition to the control signals 78 for the issue multiplexors the ISB issue logic may also generate additional control signals. These additional control signals can include a signal 82 which forces a stall in the issue logic of the processor, a modified resource vector 83, and control signals 81 which indicate, to the instruction issue logic, which registers are updated by instructions saved in the instruction side buffer. The signal 82 which forces a stall in the issue logic of the processor can be generated when the instruction side buffer is full or is close to getting full, but there are no available issue slots for issuing the ready instructions in the instruction side buffer. This can occur, for example, when the issue logic of the processor uses all of the required slots in every cycle. Another reason for forcing a stall of the issue of the processor is that the instruction side buffer is full or is close to being full, but there are no instructions in the instruction side buffer that are ready for execution. This can be the case when there is a dependency on a long latency instruction in the pipeline.

The modified resource vector 83 is generated by the ISB issue logic in SMT (simultaneous multi-threading) embodiments. The initial resource vector 74 supplied by the decode logic indicates which issue slots are in use by the group of instructions currently proceeding through the issue logic. If the ISB issue logic makes the decision to issue some of the instructions from the instruction side buffer to the unused issue slots, it adds this information to the modified resource vector, such that another thread does not attempt to use the issue slots that are used to issue instructions from the instruction side buffer.

The foregoing described mechanism for tracking dependency of instructions in the instruction side buffer is not as timing critical as the traditional issue window, because the availability of the operands is known deterministically. In some embodiments of the invention instructions are only placed in the instruction side buffer when those instructions are not part of longer dependency chains. The dependency tracking mechanism and its use in such embodiments are less complex and have fewer timing problems to be addressed than the dependency tracking mechanisms that are required for out-of-order issue processors which rely on the issue window as described above in the background section herein.

There are multiple ways to track the input operand dependencies for instructions in the instruction side buffer awaiting execution. In a preferred embodiment shown in FIG. 5, the dependencies are tracked using stall cycle counters 95. There is a counter for each source operand of every instruction in the instruction side buffer. One property of the execution flow of in-order processors is that the number of cycles an instruction needs to wait before issuing to the execution units is deterministic in the common case, and can be determined at the time of the dependency checking. When an instruction enters the instruction side buffer, the number of stall cycles needed for clearing the dependency of each source operand is saved in the corresponding stall cycle counters 95. The input signals that deliver this information are marked as 72 in FIG. 5. Then each cycle that an instruction spends in the instruction side buffer, all stall cycle counters are decremented, saturating at the value of zero. When the stall cycle counters for all input operands of a given instruction reach zero, the instruction is marked as ready for issue to the execution pipeline.

As an optional feature, the input signal 75 coming from the decode logic indicates when a new producer for the target of one of the instructions in the instruction side buffer enters the pipeline. If there are no instructions in the instruction side buffer that use the value of the target operand that is being replaced by the new value, then there cannot be any consumer for the value produced by the corresponding instruction in the instruction side buffer. If this instruction does not have any side effects on the architectural state of the processor (such as updating the state of a condition register, or that of any special purpose register) than this instruction can be canceled, without consuming the issue slot. The ability to cancel instructions in the instruction side buffer is an optional feature which can potentially improve the performance of the processor.

Instructions are executed symbolically upon entry to the ISB under different conditions in accordance with particular variations of the embodiments of the invention. In one embodiment, only instructions which cannot cause any change in the program flow are placed in the ISB. This includes most fixed point instructions, such as the instructions: add, shift, rotate, compare, and logic operations, etc. The ISB 20 (FIG. 5) can be implemented such that any instruction which might cause the program flow to be redirected to a different nonsequential location, e.g., a conditional branch instruction, will not be placed in the ISB. Another example of an instruction not permitted to enter the ISB is an instruction that might raise an exception. Exception-raising instructions include instructions that require an operand to be divided by a second operand, for example. If the second operand has a value of zero, executing the instruction would not be possible, thus raising the exception. Fixed point (“FXU”) instructions which could raise an exception, such as an integer divide instruction, will not be placed in the ISB.

Ways in which efficiencies can be achieved in the implementation and operation of the ISB 20 include the following. The ISB can be provided such that instructions are placed therein only when each instruction has no more than a predetermined number of dependencies, e.g., only one dependency, two dependencies, or some other number of dependencies. Alternatively, or in addition thereto, the dependency can be required to be of a certain type. For example, it may be required that the operand upon which the current instruction depends be the result of executing a prior instruction that is expected to complete within a predetermined number of machine cycles of the processor, i.e., within a predetermined number of clock cycles of the processor. Addition and multiplication instructions, for example, can be expected to reliably complete execution within a predetermined number of machine cycles. In another example, the dependency can be limited to one or more predetermined types of dependencies. For example, the dependency might be limited to results of executing certain types of instructions or performing certain types of fetch instructions. Alternatively, or in addition thereto, the dependency can be limited to a type which can be monitored and cleared by hardware included in the processor.

A particular way of streamlining implementation and/or operation of the ISB is to place an instruction in the ISB only after determining the operation code “opcode” of the instruction and determining from the opcode whether the instruction belongs to a predetermined class of instructions. In one example of this approach, the ISB may be provided such that only floating point type instructions can be placed therein. In another example, the ISB can be provided such that only integer type instructions can be placed therein.

A set of additional conditions can be imposed to reduce the cost and complexity of the hardware implementation. As an additional condition, one can limit the number of read operands of an instruction to be placed in the ISB. In addition, the number of targets of such instruction, and updates to be made by the instruction to special purpose registers can be limited. However, one requirement can be imposed that that instruction will not change the state of the exception register or condition register, etc. In a more complex form, if the processor implements any secondary (possibly slow) mechanism for recovering from changes in the program flow, the restriction of not changing the program flow can be relaxed to disallow the symbolic execution of only those instructions that are likely to change the program flow. In this way, slow recovery events are avoided. Under these conditions even loads can be executed symbolically. In another embodiment, the conditions under which particular instructions are placed in the ISB symbolically executed can be changed dynamically.

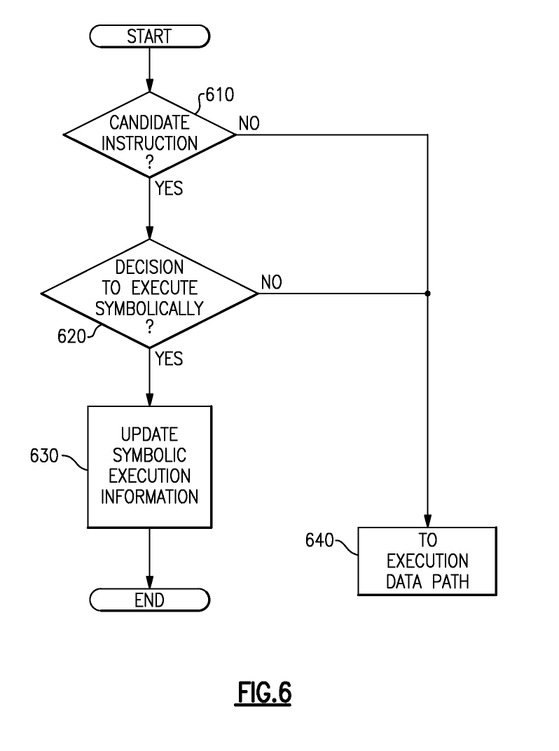

Referring now to FIG. 6, there is shown an exemplary method for symbolically executing instructions. In step 610, it is determined whether the instruction is a candidate to be executed symbolically. A variety of conditions are checked to perform this determination. Among the conditions being checked are whether the instruction raises a precise exception and whether the instruction has effects that cannot be deferred. For example, the instruction is determined not be a candidate for symbolic execution when the instruction changes the state of the computing system, e.g., its machine mode, or changes the states of registers or other states for which dependencies are not explicitly checked upon executing later instructions. When the instruction is determined to be a candidate for symbolic execution, control passes to step 620. Otherwise, if the instruction is determined to not be a candidate for symbolic execution, control is passed to step 640.

In step 620, a decision is made whether the instruction is should be executed symbolically. Typically, a decision is made to execute the instruction symbolically when structural or data hazards are present. Structural or data hazards exist when, for example, an execution unit or an input datum is not currently available. When a decision is made to execute the instruction symbolically, control passes to step 630. Otherwise, a decision is made to process the instruction immediately. In such case, the instruction is immediately placed in the execution data path for processing and execution (step 640).

In step 630, the instruction executed symbolically. Stated another way, the instruction's result is scheduled to become part of the microprocessor's committed state, subject to any pending flushes or exceptions that may be raised by preceding instructions. This is accomplished by recording the instruction to determine dependencies by future instructions on the result of the instruction.

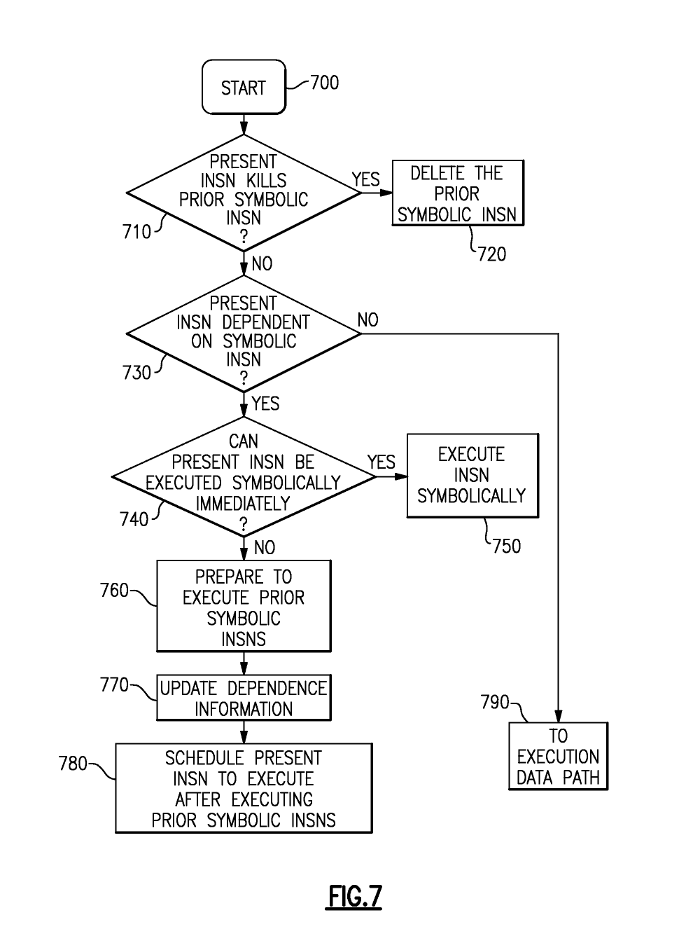

Referring now to FIG. 7, there is shown an exemplary method for the instruction issue in a microprocessor supporting symbolic execution of instructions in accordance with the present invention. The method starts with step 710.

In step 710, a test is performed to determine whether the present instruction “kills”, i.e., overwrites results to be obtained upon actually executing a previously symbolically executed instruction. In such case, that symbolically executed instruction can be deleted prior to actual execution. To ensure that deleting the instruction will not impact proper execution, all possible side effects must be considered, and the instruction to be deleted cannot feed the inputs of any other instructions in the symbolic execution buffer, or the present instruction. Stated another way, when the present instruction changes the state of the processor, the symbolically executed instruction can only be deleted when the present instruction overwrites all effects of that symbolically executed instruction. Also, if a symbolically executed instruction may raise an imprecise exception, the instruction may not be killed. If the current instruction completely overwrites the results of a previously symbolically executed instruction, control transfers to step 720. Otherwise, control passes to step 730.

Therefore, when it is determined in step 710 that the result to be obtained upon fully executing a prior symbolically executed instruction would be completely overwritten by the present instruction, the earlier symbolically executed instruction is removed from the symbolic execution buffer, and the method continues at step 730.

In step 730, a test is performed to determine whether the present instruction is dependent upon the result of a symbolically executed instruction that awaits execution. When the present instruction is not dependent upon the result of the symbolically executed instruction, the method continues at step 790 in which the present instruction is placed in the execution data path and executed. Otherwise, control passes to step 740.

When the present instruction is determined to depend on a previously symbolically executed instruction, a decision is then made (step 740) as whether the present instruction can be symbolically executed. The decision depends on two factors: whether the present is a candidate for symbolic execution; and whether there is an available symbolic execution buffer. When the decision is yes, control passes to step 750 in which the present instruction is then symbolically executed. Otherwise, control passes to step 760.

In step 760, one or more symbolically executed instructions in the symbolic execution buffer, on which execution of the present instruction depends, are identified and executed. The present instruction can depend on the one or more symbolically executed instructions either directly or transitively (i.e., indirectly by depending on the result of a symbolically executed instruction which itself depends on the result of another symbolically executed instruction. These symbolically executed instructions are then injected into the execution data path and executed before executing the present instruction. If the execution results of prior instructions present structural or data hazards to reliably executing the prior symbolically executed instructions, execution of such instructions is stalled until the condition is resolved.

As indicated in step 770, when the prior symbolically executed instructions are now being executed in the data path, and dependence information is updated to reflect the availability for results generated by one or more of the instructions. Thereafter, in step 780, the present instruction is inserted into the execution data path and executed after executing the one or more symbolically executed instructions (step 770), ending the method.

Several additional improvements can be provided in accordance with embodiments of the present invention. In one embodiment, support can be provided for overwriting only some of the outputs (results) to be obtained upon executing a previously symbolically executed instruction. In accordance with such embodiment, when one or more but not all of the outputs of a symbolically executed instruction are overwritten by a later instruction, a list of outputs that will be overwritten by the later instruction can be recorded in the symbolic execution buffer. In such way, the symbolically executed instruction can reside in the symbolic execution buffer, like other symbolically executed instructions to be inserted into the execution data path and executed when dependencies have been resolved. After execution, the outputs of executing such instruction which are identified in the recorded list as being overwritten by the later instruction will then be removed from the execution results. One way of achieving this is to modify the execution data path write back only a set of partial results when one or more of the results of executing the instruction are superseded by a successor instruction.

In yet another embodiment, symbolically executed instructions are scheduled to be executed in an execution data path whenever structural and data hazards associated with its execution have been resolved. This applies even when no other instruction is dependent on the result of executing such instruction. In one example of this embodiment, symbolically executed instructions are executed immediately upon resolving any structural and data hazards. In another example, symbolically executed instructions are executed when no other instruction can be issued at the time.

While the invention has been described in accordance with certain preferred embodiments thereof, many modifications and enhancements can be made thereto without departing from the true scope and spirit of the invention, which is limited only by the claims appended below.

1. A method of processing instructions by a processor, comprising:
queuing instructions in an instruction pipeline in a queued order;
identifying a first instruction from the queued instructions in the instruction pipeline, the first instruction having a dependency which is satisfiable within a number of instruction cycles after a current instruction in the instruction pipeline is issued;
placing the first instruction in a side buffer and issuing at least one second instruction from the queued instructions while the first instruction remains in the side buffer; and
issuing the first instruction from the side buffer after issuing the at least one second instruction in the queued order and after a number of instruction issue cycles needed to clear the dependency have passed.

2. The method of processing instructions as claimed in claim 1, wherein the number of instruction cycles needed to clear the dependency is a predetermined number and the first instruction is issued after the predetermined number of instruction cycles has passed, the method further comprising symbolically executing the first instruction when the first instruction is placed in the side buffer.

3. The method of processing instructions as claimed in claim 1, further comprising executing the second instruction when issued, thereafter executing the first instruction when it is issued.

4. The method of processing instructions as claimed in claim 1, wherein the processor includes issue logic and the issue logic is operable to issue instructions only from: a) the instructions which remain queued in the instruction pipeline in the queued order, and from b) the side buffer

5. The method of processing instructions as claimed in claim 4, wherein the issue logic issues the first instruction from the side buffer as soon as the predetermined number of instruction issue cycles has passed, even if one or more second instructions are queued in the instruction pipeline waiting to be issued.

6. The method of processing instructions as claimed in claim 4, the issue logic issues the first instruction from the side buffer after the predetermined number of instruction issue cycles have passed so long as there is no queued instruction waiting to be issued from the instruction pipeline.

7. The method as claimed in claim 1, wherein the queued instructions in the instruction pipeline are queued from a first location in a program, the method further comprising the step of queuing additional instructions in the instruction pipeline from a second location, the second location being other than a sequential location following the first location, and the step of issuing the first instruction includes issuing all instructions in the side buffer prior to queuing the additional instructions from the second location.

8. A method of processing instructions by a processor, comprising:
queuing instructions in an instruction pipeline in a queued order;
identifying a first instruction from the queued instructions in the instruction pipeline, the first instruction having a dependency which is satisfiable after a current instruction in the instruction pipeline is issued;
placing the first instruction in a side buffer; and
issuing at least one second instruction from the queued instructions while the first instruction remains in the side buffer;
determining whether a problem occurs at or before a time of executing the first instruction; and
when such problem occurs, invalidating unexecuted ones of the queued instructions in the pipeline, invalidating the first instruction and queuing third instructions in the instruction pipeline.

9. The method of processing instructions as claimed in claim 8, wherein the first instruction includes a plurality of instructions, the method further comprising receiving at least one of an external interrupt or an exception, then issuing and executing any of the first instructions which remain in the side buffer at that time by the processor, updating a state of the processor in response thereto, and only then taking action by the processor in response to the at least one of an external interrupt or exception.

10. The method of processing instructions as claimed in claim 8, wherein the dependency is determined to be satisfiable within a predetermined number of instruction issue cycles, the method further comprising: when no problem is recognized at or before execution of the first instruction, issuing the second instruction and then issuing the first instruction from the side buffer after the predetermined number of instruction issue cycles has passed.

11. The method of processing instructions as claimed in claim 8, wherein the problem includes at least one of a branch misprediction or an exception.

12. The method of processing instructions as claimed in claim 8, wherein the first instruction has no more than a predetermined number of dependencies.

13. The method of processing instructions as claimed in claim 8, wherein the dependency is selected from a group consisting of predetermined types of dependencies.

14. The method of processing instructions as claimed in claim 8, wherein satisfaction of the dependency is subject to being determined by hardware included in the processor.

15. The method of processing instructions as claimed in claim 8, wherein the step of identifying the first instruction includes determining an opcode of the instruction and placing the first instruction in the side buffer only when the opcode of the instruction belongs to a predetermined class of instructions.

16. The method of processing instructions as claimed in claimed in claim 15, wherein the predetermined class of instructions is a single class selected from floating point instructions or integer instructions.
